(19) United States
(12) Patent Application Publication
(10) Pub. No.: US 2026/0163113 A1
(43) Pub. Date: Jun. 11, 2026

(54) TRACTION BATTERY FOR A MOTOR VEHICLE AND CORRESPONDING MOTOR VEHICLE

(71) Applicant: AUDI AG, Ingolstadt (DE)

(72) Inventor: Julius RAUSCH, Heilbronn (DE)

(73) Assignee: AUDI AG, Ingolstadt (DE)

(21) Appl. No.: 19/414,596

(22) Filed: Dec. 10, 2025

(30) Foreign Application Priority Data
Dec. 11, 2024 (DE) 102024137255.9

(51) Int. Cl. H01M 10/6556; B60L 50/64; H01M 50/238; H01M 50/249

(52) U.S. Cl. CPC H01M 10/6556; B60L 50/64; H01M 50/238; H01M 50/249; H01M 2220/20

(57) ABSTRACT

A battery for a motor vehicle, including a battery housing and a battery cell arrangement arranged in the battery housing, which has multiple battery cells that press against a flat temperature control element for heat transfer. The temperature control element has at least one bulge on its side facing away from the battery cells to form at least one fluid channel in the temperature control element. The battery cell arrangement is arranged between two stiffening plates to increase stiffness. One of the stiffening plates completely overlaps the temperature control element, partially presses against the temperature control element, and has a recess that accommodates the bulge.

### FIELD

The invention relates to a traction battery for a motor vehicle, comprising a battery housing and a battery cell arrangement arranged in the battery housing, which has multiple battery cells that press against a flat temperature control element for heat transfer, wherein the temperature control element has at least one bulge on its side facing away from the battery cells to form at least one fluid channel in the temperature control element. The invention furthermore relates to a motor vehicle having a traction battery.

### BACKGROUND

Document DE 20 2020 006 035 U1 is known from the prior art, for example. This describes a battery module comprising: a cell unit containing a plurality of battery cells arranged on both surfaces of a unit plate; and a housing accommodating the cell unit and provided with a cooling device made up of at least one surface of the housing, wherein the unit plate comprises a plurality of receptacle spaces, each formed by a plate section having a flat surface and a side section projecting upwards and downwards from both sides of the plate section, and the plurality of battery cells are accommodated in each of the receptacle spaces.

Furthermore, document EP 3 905 366 B1 describes a battery box comprising a lower box body. It is provided that the lower box body comprises the following: a first plate comprising: a bottom wall; a perimeter wall connected to a perimeter of the bottom wall and extending upwards; wherein the bottom wall and the perimeter wall form a receptacle space open on top; a second plate fastened to the bottom wall by a base and engaging with the bottom wall to form a flow channel, wherein the second plate is provided with the following: a second projection projecting from a side facing toward a reinforcing beam toward the first plate and extending along a transverse direction; and an opening extending through the second projection of the second plate along a vertical direction and extending along the transverse direction, wherein the second projection of the second plate is connected in a sealed manner to the bottom wall of the first plate; and the battery box furthermore comprises the following: the reinforcing beam arranged below the second plate and extending along the transverse direction, wherein the reinforcing beam is installed at a position of a corresponding opening and is firmly connected to the first plate and/or the second plate.

Further traction batteries and housings for accommodating battery cells are known from documents WO 2024/115299 A1, EP 4 156 390 A1, and EP 2 086 035 B1.

### SUMMARY

The object of the invention is to propose a traction battery for a motor vehicle which has advantages over known traction batteries, in particular providing additional installation space in the battery housing for accommodating battery cells and also effectively stiffening the traction battery, in particular the battery cell arrangement.

This is achieved according to the invention by a traction battery for a motor vehicle. It is provided here that the battery cell arrangement is arranged between two stiffening plates to increase stiffness, wherein one of the stiffening plates completely overlaps the temperature control element, partially presses against the temperature control element, and has a recess to accommodate the bulge.

It is to be noted that the exemplary embodiments explained in the description are not restrictive; rather any variations of the features disclosed in the description, the claims, and the FIGURE are implementable.

The traction battery is preferably part of the motor vehicle, but can of course also be present separately from it, in particular before the traction battery is installed on or in the motor vehicle. The traction battery is intended and designed for the temporary storage of electrical energy for a drive device of the motor vehicle. The drive device is used to drive the motor vehicle and thus to provide a drive torque intended to drive the motor vehicle. To provide the drive torque, the drive device has at least one drive unit which is designed as an electric traction machine that is electrically connected to the traction battery.

The traction battery has the battery cell arrangement, which in turn has multiple battery cells. The battery cells are preferably prismatic cells or pouch cells. The battery cell arrangement, for example, forms part of a cell module, which in turn can be part of a battery module. The battery module preferably includes end plates and/or a clamping device in addition to the battery cell arrangement. The end plates are, for example, part of a battery module housing and accommodate the battery cell arrangement between them. The battery cell arrangement is arranged between the end plates and clamped by means of the clamping device to form the battery module. In this respect, the end plates are arranged on opposite sides of the battery cell arrangement. Preferably, the battery module is cuboid or at least approximately cuboid.

The battery cells of the battery cell arrangement are preferably electrically interconnected. For this purpose, the battery cells are arranged, for example, in such a way that the electrical connections of the battery cells are arranged on the same side and/or face toward one another. The connections are, for example, electrically connected to one another by means of one or more busbars, which are preferably also electrically connected to electrical connections of the battery module and/or the traction battery. In other words, the battery cells of the cell module are electrically connected to the terminals via the busbars.

The traction battery has the battery housing in which a battery module receptacle is present, which is intended and designed to receive the battery module or multiple battery modules. During production of the traction battery, the battery module is inserted into the battery module receptacle. Preferably, not only a single battery module is arranged in the battery housing, but rather multiple battery modules are introduced into the battery housing. In such an embodiment, the battery housing accordingly has a battery module receptacle which is intended and designed to accommodate multiple battery modules.

During operation of the traction battery, heat is generated in the battery cell arrangement, which has to be dissipated from it, or heat has to be supplied to reach a certain temperature of the battery cell arrangement. For this reason, the battery cells of the battery cell arrangement are connected to a flat temperature control element for heat transfer; this element is connected to the battery cell arrangement and, for example, forms part of the battery module. The temperature control element is basically made plate-shaped; accordingly, it can also be referred to as a temperature control plate or—depending on its intended use —as a cooling plate and/or heating plate. Preferably, the temperature control element and the battery cell arrangement form the battery module, which is inserted as such into the battery housing. During the assembly of the traction battery, the battery cell arrangement and the temperature control element are therefore introduced together as a structural unit into the battery housing.

The temperature control element has at least one fluid channel through which a fluid, in particular in the form of a coolant, flows at least sometimes. Insofar as this description refers to the coolant, it goes without saying that it can be used both to cool and to heat the battery cell arrangement; it can accordingly also be referred to as a temperature control agent. The temperature control element thus forms part of a temperature control device by means of which the battery module is at least sometimes temperature controlled. With the aid of the temperature control device, at least sometimes heat is removed from the battery cell arrangement and/or at least sometimes heat is supplied to the battery cell arrangement using the temperature control device.

For example, it is provided that a thermal conduction medium is introduced between the battery cell arrangement and the temperature control element for their reliable thermal connection. The thermal conduction medium is, for example, a thermal paste, in particular a viscous, thermally conductive material. Thermal paste can also be referred to as a “gap filler”. Alternatively, a thermally conductive adhesive can be used as the thermal conduction medium.

For weight reasons, the temperature control element is designed to be as flat as possible, thus consists of the thinnest possible material. This requires the temperature control element to have a bulge on its side facing away from the battery cells to form the fluid channel. On its side facing toward the battery cells, the temperature control element is thus planar, preferably completely and continuously, to ensure that the temperature control element presses flatly against the battery cells and thus ensures reliable heat transfer between the temperature control element and the battery cells.

For example, the temperature control element consists of two thin plates, in particular made of metal or plastic, i.e. metal plates or plastic plates, which are placed one on top of the other and interconnected. The two plates are interconnected by roll bonding, thus preferably by rolling. In the area where the fluid channel will later be located, no pressing force is applied to the plates during rolling and/or a release agent is introduced between the plates beforehand. This means that the plates are only mechanically bonded to one another by rolling or roll bonding away from the fluid channel. A pressurized fluid, such as compressed air, is then introduced between the plates, so that the fluid channel widens.

Such a temperature control element is characterized by a particularly low weight and is also producible cost-effectively. However, it has a very low stiffness, so it contributes little to the mechanical stiffness of the battery cell arrangement. For this reason, it could be possible to arrange the battery cell arrangement in a frame that defines the mechanical strength of the battery cell arrangement or the battery module.

This frame, for example, surrounds the battery cell arrangement by means of frame rails and additionally has longitudinal struts and/or transverse struts which extend through the battery cell arrangement in one or more directions and are each fastened at their ends to the frame rails. Such a frame ensures excellent strength properties of the battery module, but significantly increases the weight. For this reason, a different approach is to be taken according to the invention to ensure the strength of the battery module.

For this purpose, the battery cell arrangement is arranged between two stiffening plates, which are used to increase the stiffness of the battery module. The stiffening plates preferably consist of solid material and have a higher stiffness than the temperature control element, in particular by a factor of at least 5, at least 10 or at least 25. In particular, the stiffening plates are designed such that they support the battery cell arrangement on their own.

For example, the battery cell arrangement is accommodated between stiffening plates fastened to one another, in particular by means of at least one fastening means, preferably a bolt or the like. If the arrangement made up of battery cell arrangement and stiffening plates is now fastened via one of the stiffening plates, for example to a body of the motor vehicle, the battery cell arrangement is already reliably held due to its arrangement between the two stiffening plates. The stiffening plates are therefore in particular designed to support the weight of the battery cell arrangement.

The stiffening plates are preferably dimensioned such that they completely accommodate the battery cell arrangement between them, i.e. they have at least the same dimensions as the battery cell arrangement in two perpendicular directions. Accordingly, one of the stiffening plates completely overlaps the temperature control element, so that the temperature control element is subsequently accommodated, in particular held clamped, between the battery cell arrangement and the stiffening plate. The stiffening plate therefore presses against the temperature control element and pushes it in the direction of the battery cell arrangement or against the battery cell arrangement. Accordingly, the stiffening plates not only cause mechanical stiffening of the battery module, but also ensure reliable pressing of the temperature control element against the battery cell arrangement and thus reliable temperature control of the battery cell arrangements by means of the temperature control element.

Since the temperature control element has the bulge to form the fluid channel, the stiffening plate cannot press against the temperature control element in the area of the fluid channel, but only away from the fluid channel, in order to avoid compression and thus blocking of the fluid channel. For this reason, the stiffening plate has the recess, which accommodates the bulge, on its side facing toward the temperature control element. In particular, the recess is designed in such a way that the stiffening plate presses against the temperature control element and pushes it towards the battery cell arrangement exclusively away from the fluid channel and the bulge.

Insofar as reference is made in the scope of this description to the fluid channel or the at least one fluid channel or the bulge or at least one bulge, the statements are equivalent. Explanations regarding the fluid channel are therefore transferable to the at least one fluid channel, and explanations regarding the bulge are transferable to the at least one bulge, and vice versa. Preferably, there is moreover not just one fluid channel and therefore not just one bulge, but multiple fluid channels and consequently multiple bulges are provided. In this case, the explanations regarding the fluid channel and the bulge are transferable to each of the multiple fluid channels and each of the multiple bulges. In this case, the recess in the stiffening plate is designed in such a way that it accommodates all bulges. This purpose, multiple recesses are produced in the temperature control element or the recess consists of multiple partial recesses.

In any case, the stiffening plate only presses against the temperature control element away from the fluid channels or the bulges. This design achieves a high mechanical stiffness of the battery module while maintaining the simple and cost-effective production of the temperature control element at the same time. It is to be noted that when the traction battery is arranged as intended, the stiffening plates are located below and above the battery cell arrangement, i.e. on opposite sides of the battery cell arrangement with respect to a vertical axis of the motor vehicle.

A refinement of the invention provides that a first of the stiffening plates presses against a first housing wall of the battery housing and a second of the stiffening plates is at least partially spaced apart from a second housing wall of the battery housing and/or is supported on the second housing wall via at least one housing wall projection of the second housing wall. The battery cell arrangement is arranged together with the temperature control element and the two stiffening plates in the battery housing. In this case, the first stiffening plate presses against the first housing wall, whereas the second stiffening plate is spaced apart from the second housing wall opposite to the first housing wall. The first stiffening plate and the first housing wall are preferably located above the battery cell arrangement when the traction battery is arranged as intended, and the second stiffening plate and the second housing wall are located below the battery cell arrangement.

Preferably, the first housing wall presses against a body of the motor vehicle, so that the first stiffening plate and the body accordingly accommodate the first housing wall in a clamped manner between them. By spacing apart the second stiffening plate from the second housing wall, a cavity is formed in the battery housing. This is used in particular as underride protection for the traction battery, thus allowing a certain deformation of the second housing wall in the direction of the battery cell arrangement without damage to the battery cell arrangement being able to occur.

To ensure sufficiently high mechanical strength of the battery housing, the second housing wall preferably has a housing wall projection which extends from the second housing wall and presses against the second stiffening plate. For example, the second housing wall is fastened to the second housing plate via the housing wall projection. Preferably, multiple such housing wall projections are present, which are arranged spaced apart from one another in the battery housing. Such a design of the traction battery is also used to achieve the advantages already mentioned.

A refinement of the invention provides that the battery cells, on a side facing away from the temperature control element, press against a further flat temperature control element for heat transfer, which has at least one further bulge to form at least one further fluid channel, wherein another of the stiffening plates partially presses against the further temperature control element and has a further recess to accommodate the further bulge. The temperature control element and the further temperature control element accommodate the battery cell or the battery cell arrangement between them. The further temperature control element is preferably designed analogously to the temperature control element, so that reference is made to the corresponding statements.

The temperature control elements, i.e. the temperature control element and the further temperature control element, accommodate the battery cell between them, whereas the stiffening plates, i.e. the stiffening plate and the further stiffening plate, accommodate both the battery cells and the temperature control element between them. The stiffening plates therefore press against the temperature control elements on sides facing toward one another. In the further temperature control element, a fluid channel is also produced by forming a bulge, wherein these are referred to here as a further fluid channel and a further bulge. Analogously to the explanations for the stiffening plate, the further stiffening plate also has the recess or the further recess in which the further bulge is arranged. Reference is also made here to the explanations regarding the bulge and the recess, which are applicable analogously to the further bulge and the further recess. The further temperature control element enables particularly effective temperature control of the battery cells, namely from opposite sides.

A refinement of the invention provides that in one of the stiffening plates, on its side facing away from the battery cells, a material reduction is produced to form a predetermined breaking point defining a degassing opening. The battery cells preferably each have a degassing valve which opens in case of overpressure occurring in the battery cell, so that the overpressure can be discharged in the direction of an outside environment. To prevent the pressure in the battery housing from rising excessively strongly in this case and uncontrolled deformation of the battery housing from being able to occur, the stiffening plates and the battery housing are designed to release a flow path from the battery cells to the outside environment if overpressure occurs.

For this purpose, the stiffening plate has the predetermined breaking point at which the stiffening plate gives way under pressure and releases the degassing opening. The predetermined breaking point is achieved by a material reduction, i.e. by a local reduction of a wall thickness of the stiffening plate. The material reduction is produced on the side of the stiffening plate facing away from the battery cells. It is particularly preferably present under the stiffening plates when the traction battery is arranged as intended. Such a design ensures a high level of safety for the traction battery.

A refinement of the invention provides that in addition to the battery cell arrangement, a further battery cell arrangement is arranged and battery cells of the further battery cell arrangement press against the temperature control element and/or the further temperature control element for heat transfer. The battery cells of the battery cell arrangement are preferably arranged next to one another in a first direction. The further battery cell arrangement also has battery cells arranged next to one another in the first direction. The battery cell arrangement and the further battery cell arrangement are arranged next to one another in a second direction perpendicular to the first direction, so that ultimately the battery cells of the battery cell arrangement and the further battery cell arrangement are parallel to one another.

The battery cell arrangement and the further battery cell arrangement are part of the same cell module and consequently both press against the temperature control element and/or the further temperature control element for heat transfer. In principle, any number of such additional battery cell arrangements can be part of the traction battery; for example, there are a total of at least five battery cell arrangements per cell module. The use of a single temperature control element and/or a single further temperature control element for temperature control of both the battery cell arrangement and the further battery cell arrangement enables particularly effective heat dissipation or supply.

A refinement of the invention provides that the battery cell arrangement, the further battery cell arrangement, and the temperature control element form a cell module and that a further cell module is arranged adjacent to the cell module, wherein the cell module and the further cell module are arranged between the two stiffening plates and the one stiffening plate completely overlaps a temperature control element of the further cell module and partially presses against it. The cell module already mentioned comprises at least the battery cell arrangement, the further battery cell arrangement, and the temperature control element, which overlaps the two battery cell arrangements and controls their temperature. The further temperature control element can of course also be part of the cell module.

The cell module and the at least one further cell module together with the stiffening plates form the battery module. In addition to the battery module, the traction battery can have at least one further battery module, which is also arranged in the battery housing. In principle, any number of such battery modules can be present and accommodated by the battery housing. The traction battery or battery module has multiple cell modules and accordingly, in addition to the cell module, has the further cell module which is arranged adjacent to the cell module, in particular in the second direction already mentioned.

Naturally, the traction battery can have any number of cell modules, so that in addition to the cell module, any number of further cell modules can be present. In order to achieve a particularly effective improvement in the mechanical properties of the traction battery, both the cell module and the additional cell module are arranged between the two stiffening plates. In particular, the two stiffening plates each completely overlap the cell module and the further cell module. This applies in particular to all cell modules of the battery module or the traction battery.

The stiffening plate completely overlaps and partially presses against both the temperature control element of the cell module and the temperature control element of the further cell module, more generally the temperature control elements of all cell modules of the battery module. The recess(es) of the stiffening plate are arranged and designed here in such a way that they accommodate the bulge of the overlapped temperature control element. This preferably applies analogously to the further stiffening plate. The advantages already mentioned are achieved in this way.

A refinement of the invention provides that the cell module and the further cell modules are arranged directly adjacent to one another, in particular without a stiffening strut arranged between them. The stiffening strut, for example, in the form of the longitudinal strut or the transverse strut, has already been discussed. The use of stiffening plates eliminates the need for the stiffening strut that would otherwise be present between the cell modules. For example, it is intended that such a stiffening strut is only present between battery modules arranged adjacent to one another. Accordingly, the weight of the traction battery can be significantly reduced despite its excellent stiffness.

A refinement of the invention provides that the stiffening plates are fastened directly to one another, in particular by means of a fastening element arranged between the battery cells, for example a bolt. The stiffening plates are therefore not only connected to one another via the battery cell arrangement, but are also fastened directly to one another, thus bypassing the battery cell arrangement. Preferably, for this purpose the fastening element engages on one side of the battery cell arrangement on one of the stiffening plates and on the other side of the battery cell arrangement on another of the stiffening plates and is firmly connected to them, so that the stiffening plates are also held rigidly together via the fastening element. A bolt, preferably a threaded bolt, is used as a fastening element, for example. The direct fastening of the stiffening plates to one another enables a particularly high stiffness of the resulting arrangement made up of stiffening plates and battery cell arrangement.

The invention furthermore relates to a motor vehicle comprising a traction battery, in particular attraction battery according to the explanations in the scope of this description, wherein the traction battery comprises a battery housing and a battery cell arrangement arranged in the battery housing, which has multiple battery cells that press against a flat temperature control element for heat transfer, wherein the temperature control element has at least one bulge on its side facing away from the battery cells to form at least one fluid channel in the temperature control element. It is provided here that the battery cell arrangement is arranged between two stiffening plates to increase stiffness, wherein one of the stiffening plates completely overlaps the temperature control element, partially presses against the temperature control element, and has a recess to accommodate the bulge.

The advantages of such a design of the motor vehicle or the traction battery have already been discussed. Both the motor vehicle and the traction battery can be refined according to the explanations in this description, to which reference will therefore be made.

A refinement of the invention provides that at least one of the stiffening plates is fastened to a body of the motor vehicle by means of a fastening element and the battery cell arrangement is connected to the body exclusively via the one stiffening plate and the fastening element. Preferably, the stiffening plate is thus fastened to the body and the stiffening plates are additionally fastened directly to one another. Ultimately, the battery cell arrangement is positioned between the stiffening plates and connected to the body or fastened to the body via these plates. No further mechanical load-bearing connection between the battery cell arrangements and the body is provided. This reliably achieves the advantages explained above, in particular weight reduction.

The features and feature combinations described in the description, in particular the features and feature combinations described below in the description of the FIGURE and/or shown in the FIGURE may be used not only in the respective specified combination, but also in other combinations or alone, without departing from the scope of the invention, in particular within the scope of the claims. The invention should therefore also be considered to comprise embodiments that are explicitly not shown or explained in the description and/or the FIGURE, but emerge from the explained embodiments or can be derived from them, in particular within the scope of the claims.

### BRIEF DESCRIPTION OF THE FIGURES

In the following, the invention will be explained in greater detail with reference to the exemplary embodiments depicted in the drawings, without this restricting the invention. In the single FIGURE

FIG. 1 shows a schematic sectional view of an area of a motor vehicle which has a traction battery fastened to a body of the motor vehicle.

### DETAILED DESCRIPTION

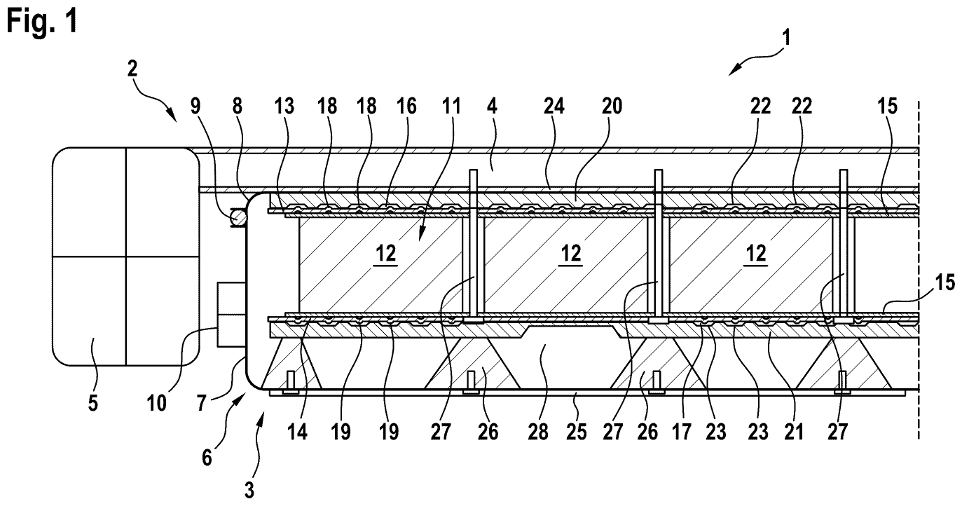

FIG. 1 shows a schematic sectional view of a motor vehicle 1, of which in particular a body 2 and a traction battery 3 are shown. A cross member 4 and a rocker panel 5 supporting the cross member 4 are shown of the body 2. The traction battery 3 is fastened to the cross member 4. The traction battery 1 has a battery housing 6, which is composed of at least a first housing part 7 and a second housing part 8. The first housing part 7 is provided as the base tray and the second housing part 8 as the housing cover. The two housing parts 7 and 8 are sealed against one another at a seam by means of a seal 9. Additionally, a reinforcement 10 in the form of a hollow profile is arranged on the battery housing 6 to improve crash resistance.

The battery housing 6 contains a battery cell arrangement 11, which in the exemplary embodiment shown here has multiple battery cells 12 arranged next to one another in a first direction, some of which are identified by way of example. The battery cell arrangement 11 is accommodated between a temperature control element 13 and a further temperature control element 14, which press against the battery cells 2 on opposite sides for heat transfer. Preferably, the temperature control elements 13 and 14 are thermally connected to the battery cells 12 via a thermal conduction medium 15. The temperature control elements 13 and 14 each have one or more fluid channels 16 and 17 respectively, which are formed by a bulge 18 and 19 respectively on a side facing away from the battery cells 12. The bulges 18 and 19 are only partially identified as examples.

To increase stiffness, the battery cell arrangement 11 is arranged between two stiffening plates 20 and 21. Each of the stiffening plates 20 and 21, on the one hand, and the battery cell arrangement 11, on the other, accommodate one of the temperature control elements 13 and 14 between them in a clamping manner. To still ensure reliable temperature control of the battery cell arrangement 11, the stiffening plates 20 and 21 have recesses 22 and 23 respectively (only partially identified) which accommodate the bulges 18 and 19 respectively. It can be seen that the stiffening plate 20 presses against a housing wall 24, which is part of the second housing part 8. The stiffening plate 21, in contrast, is arranged spaced apart from a housing wall 24 formed by the first housing part 7. In the illustrated exemplary embodiment, the stiffening plate 21 is supported on the housing wall via housing wall projections 26.

For example, it is provided that the stiffening plates 20 and 21 are fastened directly to one another, in particular by means of a fastening element 27, for example a bolt. The fastening element is preferably also used to fasten the traction battery 3 to the body 2, in particular to the cross member 4. For example, the fastening element 27 engages on the stiffening plate 21 and pushes it and thus the battery cell arrangement 11 in the direction of the stiffening plate 20, which in turn is pushed against the body 2. This ensures reliable fastening of the traction battery 3 to the body 2. Furthermore, an extremely high stiffness of the traction battery 3 as such is guaranteed. A degassing opening 28 is also visible, which is releasable by a predetermined breaking point formed by a material weakening of the stiffening plate 21.

### LIST OF REFERENCE NUMERALS

1 motor vehicle
2 body
3 traction battery
4 cross member
5 rocker panel
6 battery housing
7 first housing part
8 second housing part
9 seal
10 reinforcement
11 battery cell arrangement
12 battery cell
13 temperature control element
14 temperature control element
15 thermal conduction medium
16 fluid channel
17 fluid channel
18 bulge
19 bulge
20 stiffening plate
21 stiffening plate
22 recess
23 recess
24 housing wall
25 housing wall
26 housing wall projection
27 fastening element
28 degassing opening

1. A traction battery for a motor vehicle, comprising: a battery housing and a battery cell arrangement arranged in the battery housing, which has multiple battery cells that press against a flat temperature control element for heat transfer, wherein the temperature control element has at least one bulge on its side facing away from the battery cells to form at least one fluid channel in the temperature control element, wherein the battery cell arrangement is arranged between two stiffening plates to increase stiffness, wherein one of the stiffening plates completely overlaps the temperature control element, partially presses against the temperature control element, and has a recess that accommodates the bulge.

2. The traction battery as claimed in claim 1, wherein a first of the stiffening plates presses against a first housing wall of the battery housing and a second of the stiffening plates is at least partially spaced apart from a second housing wall of the battery housing and/or is supported on the second housing wall via at least one housing wall projection of the second housing wall.

3. The traction battery as claimed in claim 1, wherein the battery cells, on a side facing away from the temperature control element, press against a further flat temperature control element for heat transfer, which has at least one further bulge to form at least one further fluid channel, wherein another of the stiffening plates partially presses against the further temperature control element and has a further recess to accommodate the further bulge.

4. The traction battery as claimed in claim 1, wherein in one of the stiffening plates, on its side facing away from the battery cells, a material reduction is produced to form a predetermined breaking point defining a degassing opening.

5. The traction battery as claimed in claim 1, wherein in addition to the battery cell arrangement, a further battery cell arrangement is arranged and battery cells of the further battery cell arrangement press against the temperature control element and/or the further temperature control element for heat transfer.

6. The traction battery as claimed in claim 1, wherein the battery cell arrangement, the further battery cell arrangement, and the temperature control element form a cell module and that a further cell module is arranged adjacent to the cell module, wherein the cell module and the further cell module are arranged between the two stiffening plates and the one stiffening plate completely overlaps a temperature control element of the further cell module and partially presses against it.

7. The traction battery as claimed in claim 1, wherein the cell module and the further cell module are arranged directly adjacent to one another.

8. The traction battery as claimed in claim 1, wherein the stiffening plates are fastened directly to one another.

9. A motor vehicle comprising a traction battery, in particular a traction battery as claimed in claim 1, wherein the traction battery comprises a battery housing and a battery cell arrangement arranged in the battery housing, which has multiple battery cells that press against a flat temperature control element for heat transfer, wherein the temperature control element has at least one bulge on its side facing away from the battery cells to form at least one fluid channel in the temperature control element, wherein the battery cell arrangement is arranged between two stiffening plates to increase stiffness, wherein one of the stiffening plates completely overlaps the temperature control element, partially presses against the temperature control element, and has a recess that accommodates the bulge.

10. The motor vehicle as claimed in claim 9, wherein at least one of the stiffening plates is fastened to a body of the motor vehicle by means of a fastening element and the battery cell arrangement is connected to the body exclusively via the one stiffening plate and the fastening element.

11. The traction battery as claimed in claim 2, wherein the battery cells, on a side facing away from the temperature control element, press against a further flat temperature control element for heat transfer, which has at least one further bulge to form at least one further fluid channel, wherein another of the stiffening plates partially presses against the further temperature control element and has a further recess to accommodate the further bulge.

12. The traction battery as claimed in claim 2, wherein in one of the stiffening plates, on its side facing away from the battery cells, a material reduction is produced to form a predetermined breaking point defining a degassing opening.

13. The traction battery as claimed in claim 3, wherein in one of the stiffening plates, on its side facing away from the battery cells, a material reduction is produced to form a predetermined breaking point defining a degassing opening.

14. The traction battery as claimed in claim 2, wherein in addition to the battery cell arrangement, a further battery cell arrangement is arranged and battery cells of the further battery cell arrangement press against the temperature control element and/or the further temperature control element for heat transfer.

15. The traction battery as claimed in claim 3, wherein in addition to the battery cell arrangement, a further battery cell arrangement is arranged and battery cells of the further battery cell arrangement press against the temperature control element and/or the further temperature control element for heat transfer.

16. The traction battery as claimed in claim 4, wherein in addition to the battery cell arrangement, a further battery cell arrangement is arranged and battery cells of the further battery cell arrangement press against the temperature control element and/or the further temperature control element for heat transfer.

17. The traction battery as claimed in claim 2, wherein the battery cell arrangement, the further battery cell arrangement, and the temperature control element form a cell module and that a further cell module is arranged adjacent to the cell module, wherein the cell module and the further cell module are arranged between the two stiffening plates and the one stiffening plate completely overlaps a temperature control element of the further cell module and partially presses against it.

18. The traction battery as claimed in claim 3, wherein the battery cell arrangement, the further battery cell arrangement, and the temperature control element form a cell module and that a further cell module is arranged adjacent to the cell module, wherein the cell module and the further cell module are arranged between the two stiffening plates and the one stiffening plate completely overlaps a temperature control element of the further cell module and partially presses against it.

19. The traction battery as claimed in claim 4, wherein the battery cell arrangement, the further battery cell arrangement, and the temperature control element form a cell module and that a further cell module is arranged adjacent to the cell module, wherein the cell module and the further cell module are arranged between the two stiffening plates and the one stiffening plate completely overlaps a temperature control element of the further cell module and partially presses against it.

20. The traction battery as claimed in claim 5, wherein the battery cell arrangement, the further battery cell arrangement, and the temperature control element form a cell module and that a further cell module is arranged adjacent to the cell module, wherein the cell module and the further cell module are arranged between the two stiffening plates and the one stiffening plate completely overlaps a temperature control element of the further cell module and partially presses against it.
